(19) United States
(12) Patent Application Publication
(10) Pub. No.: US 2022/0139047 A1
(43) Pub. Date: May 5, 2022

(54) SYSTEMS AND METHODS FOR RECREATING OR AUGMENTING REAL-TIME EVENTS USING SENSOR-BASED VIRTUAL REALITY, AUGMENTED REALITY, OR EXTENDED REALITY

(71) Applicant: SCORCHED ICE INC., Okotoks (CA)

(72) Inventors: John LOWE, Okotoks (CA); Bruce WRIGHT, Okotoks (CA); Adile ABBADI-MACINTOSH, Calgary, Alberta (CA)

(73) Assignee: SCORCHED ICE INC., Okotoks (CA)

(21) Appl. No.: 17/435,156

(22) PCT Filed: Feb. 28, 2020
(86) PCT No.: PCT/CA2020/000019

§ 371 Date: Aug. 31, 2021

Related U.S. Application Data
(60) Provisional application No. 62/812,744, filed on Mar. 1, 2019.

(51) Int. Cl. G06T 19/00; G06F 3/01

(52) U.S. Cl. CPC G06T 19/006; G06F 3/011

(57) ABSTRACT

Many attempts at translating real-time events (e.g., sporting events) to augmented reality (AR)-based, extended or Data Processing Service and Technology Environment cross reality (XR)-based, or virtual reality (VR)-based experiences and environments rely upon mapping captured surface image data (such as video, pictures, etc.) of objects (e.g., balls, players, etc.) onto computer-modeled environments. This surface mapping results in imperfect and unsatisfactory virtual reality experiences for the viewer because the images and sounds do not perfectly correlate to the motion and states of the real-time objects and players. To solve this problem, and create an improved experience fo the virtual spectator, a more accurate and immersive virtual, extended, or aumented reality environment can be created by relying on data from a network system of sensors embedded throughout the real-time environment during the event in question. This network system would capture data that would otherwise be difficult and/or impossible to determine solely from surface data.

### BACKGROUND OF THE INVENTION

Many attempts at translating real-time events (e.g., sporting events) to augmented reality (AR)-based, extended or cross reality (XR)-based, or virtual reality (VR)-based experiences and environments rely upon mapping captured surface image data (such as video, pictures, etc.) of objects (e.g., balls, players, etc.) onto computer-modeled environments. This surface mapping results in imperfect and unsatisfactory virtual reality experiences for the viewer because the images and sounds do not perfectly correlate to the motion and states of the real-time objects and players. There is a need for a method and system to recreate real-time events in a manner that provides the virtual spectator a more seamless and realistic VR, AR, or XR experience of the real-time event.

### SUMMARY OF THE INVENTION

To solve this problem, and create an improved experience for the virtual spectator, a more accurate and immersive virtual, extended, or augmented reality environment can be created by relying on data from a network system of sensors embedded throughout the real-time environment during the event in question. This network system would capture data that would otherwise be difficult and/or impossible to determine solely from surface data.

Additionally, by layering and correlating surface data (e.g., video, images, sound, etc.) to the sensor-based data, the verisimilitude of the virtual, extended, or augmented environment will have increased, and the virtual, extended, or augmented reality experience of the user will be enhanced and improved. In some embodiments, certain sensor measurements are used to create calibration curves for the other sensor measurements. These calibration curves allow for total sensor calibration, to ensure that the sensor data collected is as accurate as possible.

### BRIEF DESCRIPTION OF THE DRAWINGS

FIG. 1 depicts an example event participation suit.

FIG. 2 depicts possible sensor locations on an event participant.

FIG. 3 depicts an example modular sensor array.

FIG. 4 depicts examples of embedded sensor arrays in example event objects.

FIG. 5 depicts an example sensor array layout for an example event facility.

FIG. 6 depicts an example data processing service and technology environment.

### DETAILED DESCRIPTION OF THE INVENTION

The system may be broken down into the following core components:

Participant Sensor Array

During an event, such as a sporting game, there are a number of individuals whose participation is essential to bring the event to life. From coaches to players, to referees—even to spectators—each individual participant brings an important aspect to the event in question and helps complete the event experience. These individuals will be referred to as “event participants” herein.

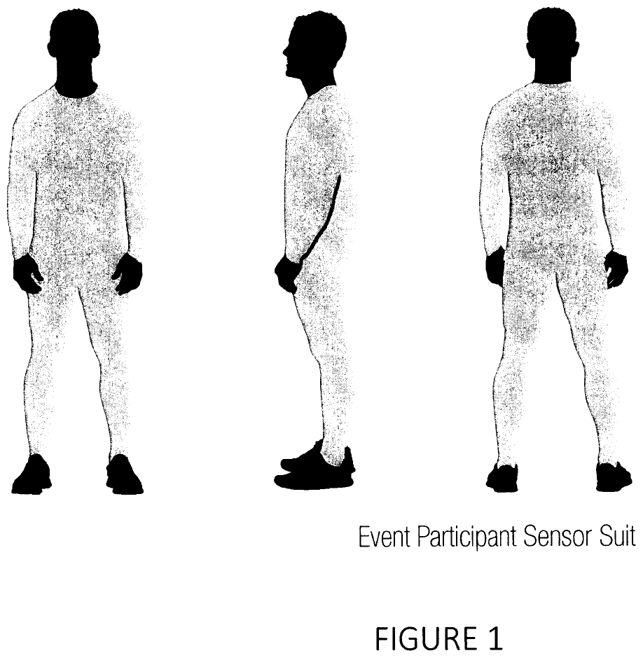

Event participants are a source of data with the potential to enhance the experience of a virtual spectator. Collecting event participant data is unique to each individual event participant and must be captured using a sensor array system that can create a complete picture of that participant's contribution to the event in question. FIG. 1 illustrates a possible embodiment of an event participant sensor suit that may be used in combination with a participant sensor array system.

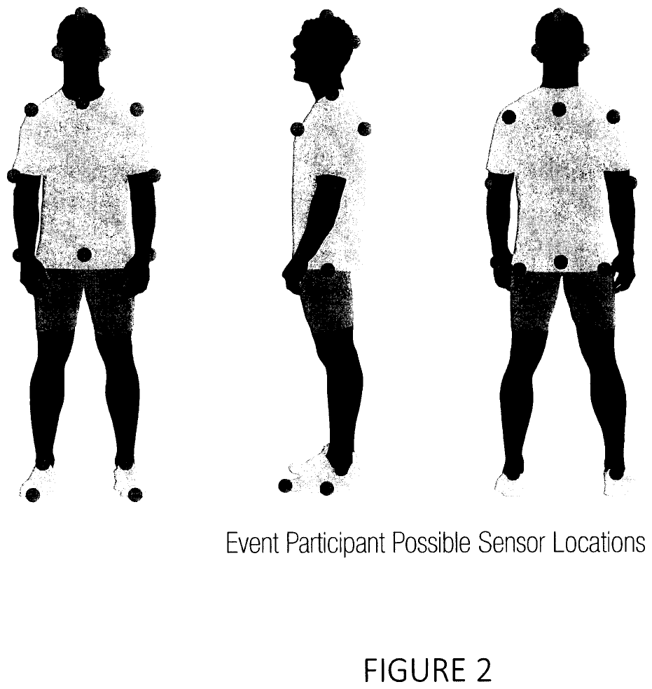

The participant sensor array system is composed of sensors that are located on the participant themselves. As depicted in FIG. 2, those sensors may be strategically attached to the participant's body (or event participant sensor suit) to collect specific bits of sensor data relevant to how that event participant participates during the event. As such, the number of sensors attached could vary by each participant, from a single sensor to potentially hundreds of sensors, or even, as depicted in FIG. 2, a complete sensor suit that would be worn by the event participant.

In some example embodiments, the sensors in the sensor array system may be attached at specific points on the event participant's body to capture specific and unique movements at those points. As such, measurements between those points would be required in order to not only properly calibrate the sensor array system but also increase the accuracy of the data collected, all helping to create a complete model of the event participant's data contribution to the overall data set comprising the event experience.

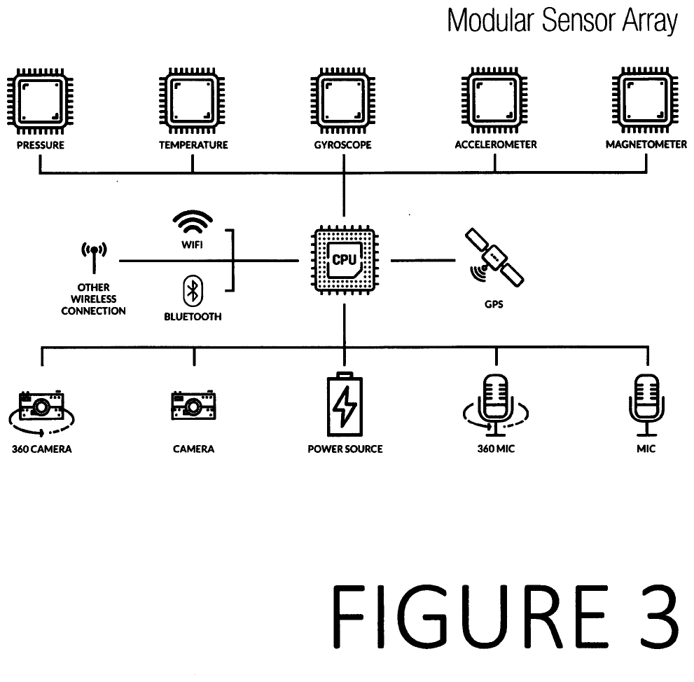

In one example embodiment, as depicted in FIG. 3, the participant sensor array system may be a modular sensor array composed of sensors configured to measure data, including but not limited to, acceleration, speed, velocity, position in three-dimensional space (e.g., via a gyroscope), temperature, and pressure. The modular sensor array may also include small cameras mounted on the participant's body at specific points to collect video data from the perspective of the event participant at various times in the event. The modular sensor array may also include audio sensors (e.g., microphone array) in order to collect three-dimensional sounds experienced and/or created by, the participant.

Event Object Sensor Array

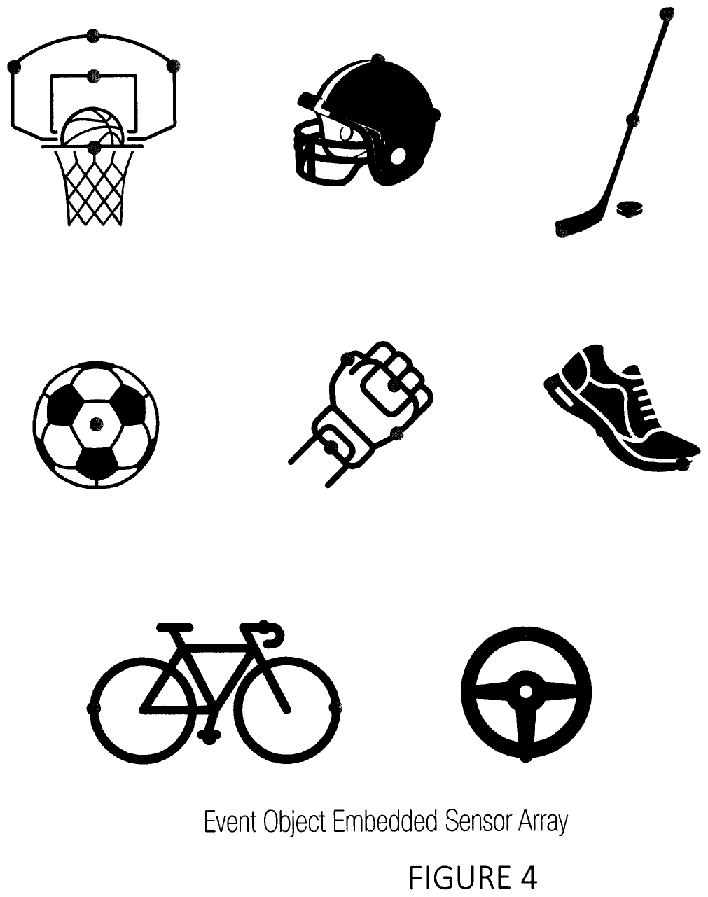

Like the individuals who participate during an event, there is often an associated physical object that is a major participant in, or even a focus of, the event's activities. As depicted in FIG. 4, examples of this object may be, but are not limited to, a ball, puck, glove, stick, racquet, skate, shoe, or net. Depending on the character of the event, these physical objects may be extremely important to the event in question and form an integral part of the event experience.

Like the event participant individuals, the physical objects are a source of data that can help enhance the experience of a virtual spectator. Data collected from a physical object is unique to that object and may be captured using a sensor array system that aids in compiling a complete picture of the object's specific contributions to the event in question.

As depicted in FIG. 4, and similar to the depictions of the example participant sensor arrays in FIG. 2, the object sensor array may be composed of sensors that are strategically attached to specific points on the physical object itself. This strategic positioning would allow collection of specific bits of sensor data relevant to the object's event participation. As such, the number of sensors and the type of sensors used could vary by object anywhere from a single sensor to potentially hundreds of sensors.

Like the modular sensor array depicted in FIG. 3 that may be integrated in the event participant sensor array system—the object sensors may be configured to measure object data including, but not limited to, acceleration, speed, velocity, position in three-dimensional space (e.g., gyro), temperature, and/or pressure. Depending on requirements, other sensors may be incorporated, including light intensity sensors, position sensors (e.g., ultra-wideband (UWB) based sensors), time-of-flight sensors (e.g., ultrasonic sensors), or air quality sensors for capturing information related to air quality, such as smell, humidity, oxygen, volatile organic compounds (VOCs), etc. The modular sensor array could also include small cameras mounted on the object at specific points to collect video data from the perspective of the object at various points in the event. The modular sensor array could include audio sensors (e.g., a mic array) in order to collect three-dimensional sound located around, and produced by, the object.

The object sensor array system may also establish a mesh-style network between sensor-embedded objects where data is shared, used, analyzed and interpreted to help both calibrate the system of sensors and correlate the data in order to improve the overall quality of data being collected from any participating individual objects. This mesh-style network may be further extended to integrate modular sensor arrays incorporated into event participant suits.

As depicted in FIG. 3, the modular sensor array may also include a power source and central processing unit (CPU) for enabling and coordinating sensor data collection. The modular sensor array may also support various wireless connection standards (e.g., Wi-Fi, Bluetooth, 3G, 4G, 5G, etc.). The modular sensor array may also support global positioning system (GPS) data standards for reporting and receiving GPS data.

Event Facility Sensor Array

The facility at which the event occurs may also play an important part of the overall event experience. The surface upon which the event happens (e.g., grass, ice, wood floor, pavement, etc.) and the lights, acoustics, location of stands, and even the shape of building will all play an important role in contributing to a virtual spectator's overall experience.

In many respects, the event facility may be treated as just another item within the event object list noted above (e.g., the stands could be thought of in the same context as a net on the field). However, the event facility is also unique in that the facility may define the boundaries of the event and the data collected therein. These boundaries provide a frame of reference and present a unique data capture opportunity that is quite difficult to accomplish solely with sensors mounted on the event objects and participants—the tracking of the object and participant sensors themselves relative to the facility itself.

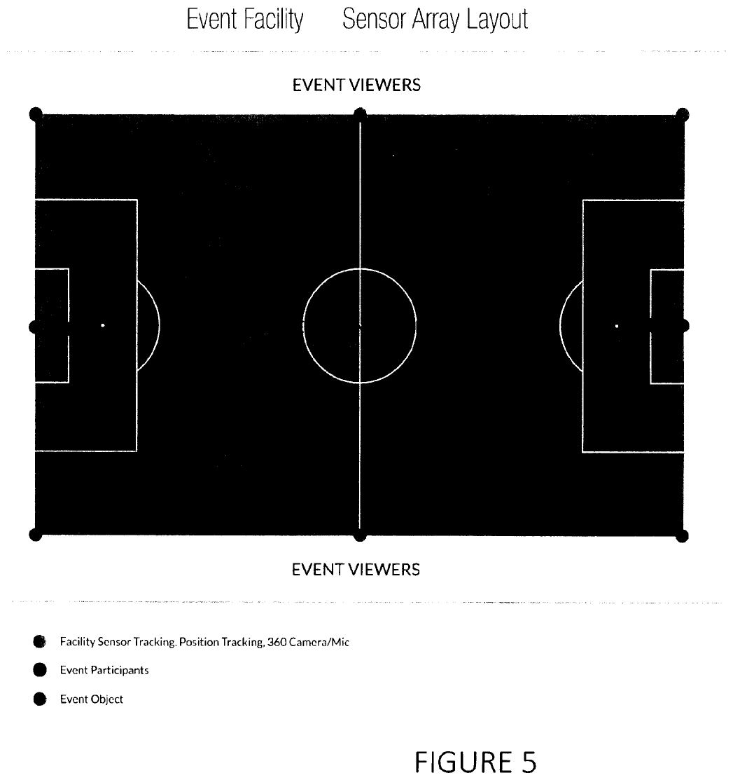

As depicted in an example embodiment of FIG. 5, because the event happens within the boundaries of the facility, sensors may be attached at specific, strategic points within the boundary itself and those event facility sensors could be used to track, measure, calculate, capture, and process data from the object/participant sensors systems and arrays. A primary use for this type of event facility sensor array is to track the relative positions of the event objects and event participants. Another event facility sensor array may capture additional data related to pressure, air quality, light intensity, or three-dimensional position in space, in order to augment data captured from the object and event participant sensor arrays.

These object and participant positions are almost impossible to track solely at the object/participant level because there is no discernible frame of reference. By fixing and locating sensors within the facility itself, triangulation and algorithmic work may be done to determine the exact location of event objects and event participants, thus improving and enhancing the VR/AR/XR data set used to create the virtual spectator's experience.

The facility sensor array system may also be used to capture, relay, process, and manipulate data from event object and event participant sensor arrays in order to not only further enhance the VR/AR/XR experience, but also to calibrate and correlate data collected from event object and event participant sensory arrays located within the event facility boundaries.

The facility sensor array, as with the object sensor array, may be comprised of camera and mic sensors and sensor arrays for capturing data in order to provide a three-dimensional view of the overall facility. Additionally, sensors within the facility may capture data including, but not limited to, temperature, pressure, light, sound, and vibration.

Data Processing Service and Technology

The combination of data collected from the event facility sensor system, the event object sensor systems, and the event participant sensor systems during an event can provide a complete picture of the event in raw data form subject to subsequent processing and distribution.

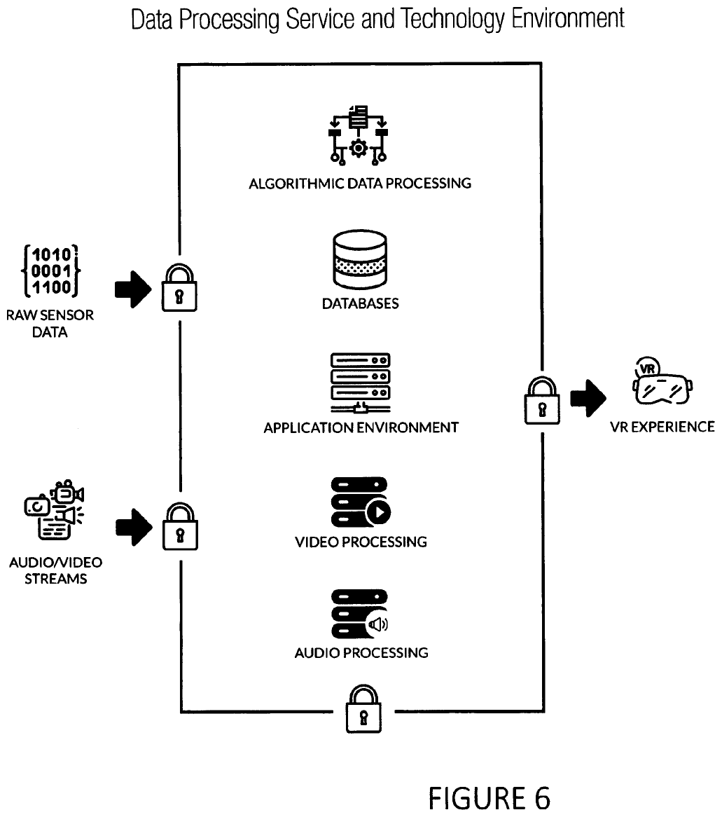

FIG. 6 depicts an example data processing service and technology environment. This processing may capture, manipulate, process, enhance, correlate, and distribute data to ultimately provide the virtual, cross, or augmented reality experience. The example centralized data service may receive all data from all sensor arrays within the event facility boundaries, and use this data to create a virtual reality spectator experience. In other embodiments an augmented reality or extended reality spectator experience may be created from the processed data.

The data processing service may feature databases, software, hardware, and other technology to allow for specific uses of the data collected by the above described sensor array systems. Once the sensor data is collected, processed and manipulated, it can be distributed through various channels to implement the virtual, augmented, or extended or cross reality-based experience of the event for a spectator.

The data processing service may utilize algorithms to properly analyze, process, and correlate sensor data in near real-time so that the data could be used by external services in rendering the virtual, augmented, or extended or cross reality experience for a spectator.

The data processing service may also feature advanced security and encryption technology to protect collected sensor data prevent interception and/or manipulation that may corrupt or change the virtual, augmented, or extended or cross reality experience and/or results of the processed data.

Integrated Solution for Real-Time Event Spectatorship

Coordinating and integrating the above-described components will allow a real-time event to be experienced remotely and recreated for an event spectator in an augmented, virtual, or extended reality space. In one embodiment, this augmented, virtual, or extended reality space may be presented or displayed to a spectator through virtual reality hardware, such as virtual reality goggles and gloves. In another embodiment, this space may be presented or displayed to a spectator through mobile phone or tablet technology.

The sensor-based data allows for the creation of a more accurate virtual, augmented, or extended reality-based representation of a participant's body in three dimensions during the event, than for example a system based solely on captured images and sound or other surface data. For example, the data collected from the participant sensor array allows for an accurate three dimensional model of the player's physique and associated movements to be rendered. Superimposed over this sensor-based model of the player is a “skin” or three-dimensional surface scan of the player's likeness that completes the three-dimensional representation comprising a sensor data-based player avatar.

The sensor data-based player avatar can then be merged with incoming data captured by the event object sensor array and facility sensor array (e.g., audio-video capture) that would then be processed to provide a realistic real-time (or near real-time) representation of the event. This real-time representation could allow a viewer to place themselves anywhere in the virtual field of play so that they can experience and view the event from any available perspective.

In some embodiments, the viewer will also be able to rewind gameplay and watch it from different perspectives within the event field. In other embodiments, a viewer may be able to accelerate or slow the motion of the event to experience the event from different temporal viewpoints and perspectives.

In some embodiments, the addition of the microphone arrays within the participant, object, and facility sensor arrays allows for the capture of sound data that will facilitate the creation of a three-dimensional sound environment. This sound data can then be correlated to the rest of the sensor-based data and video image data to create a virtual soundscape experience that allows the viewer to experience the sound during the event from any position they choose.

In this arrangement, the viewer could move their position and the soundscape would change based on where they choose to observe the virtual event. For example, if a viewer observing a hockey match positions themselves close to a net, that viewer may experience the sound of the puck approaching the net and being saved by a goalie more intensely, or loudly, than a viewer that observes the game from a position mid-rink.

Fully processing, correlating, and integrating a real-time three-dimensional soundscape, real-time sensor-based data from participants, objects and the facility, three-dimensional image scans, and real-time video data allows for the creation of a truly immersive and realistic virtual, augmented, or extended reality-based recreation of an event happening in real time in the real-world that is far superior to a virtual experience based solely on captured and mapped surface data.

What is claimed is:

1. A system for augmenting or virtually recreating a real-time event in a facility, said system comprising:
at least one participant sensor module located on a participant in the real-time event, the at least one participant sensor module configured to gather participant data;
at least one object sensor module located on an object in the real-time event, the at least one object sensor module configured to gather object data;
at least one facility sensor module located in the facility, the at least one facility sensor module configured to gather facility data; and
a processor configured to generate an augmented or virtual recreation of the real-time event by processing the participant data, object data, and facility data.

2. The system of claim 1, wherein the participant data comprises at least one of: acceleration, speed, velocity, position in three-dimensional space, temperature, pressure, air quality, light intensity, time-of-flight, audio, or video.

3. The system of claim 1, wherein the object data comprises at least one of: acceleration, speed, velocity, position in three-dimensional space, temperature, pressure, air quality, light intensity, time-of-flight, audio, or video.

4. The system of claim 1, wherein the facility data comprises at least one of: position in three-dimensional space, temperature, pressure, air quality, light intensity, audio, or video.

5. The system of claim 4, wherein the facility data further comprises triangulated position data related to the at least one participant sensor module or the at least one object sensor module.

6. The system of claim 1, wherein the at least one participant sensor module, the at least one object sensor module, and the at least one facility sensor module are configured for wireless transmission of data.

7. The system of claim 1, wherein the at least one participant sensor module, the at least one object sensor module, and the at least one facility sensor module are in communication with each other and configured to provide a mesh network.

8. The system of claim 1, wherein the data processing service is configured to provide a slow motion version of the augmented or virtual recreation of the real-time event.

9. The system of claim 1, wherein the data processing service is configured to provide the augmented or virtual recreation of the real-time event that is capable of being rewound.

10. The system of claim 1, wherein the data processing service generates the augmented or virtual recreation of the real-time event by combining captured audio and video data with the participant data, object data, and facility data.

11. The system of claim 10, wherein the captured audio data comprises three-dimensional audio.

12. A method for augmenting or virtually recreating a real-time event, said method comprising:
gathering participant data from at least one participant sensor module located on a participant in the real-time event;
gathering object data from at least one object sensor module located on an object in the real-time event;
gathering facility data from at least one facility sensor module located in the facility; and
processing the participant data, object data, and facility data to generate an augmented or virtual recreation of the real-time event.

13. The method of claim 12, wherein the participant data comprises at least one of: acceleration, speed, velocity, position in three-dimensional space, temperature, pressure, air quality, light intensity, time-of-flight, audio, or video.

14. The method of claim 12, wherein the object data comprises at least one of: acceleration, speed, velocity, position in three-dimensional space, temperature, pressure, air quality, light intensity, time-of-flight, audio, or video.

15. The method of claim 12, wherein the facility data comprises at least one of: position in three-dimensional space, temperature, pressure, air quality, light intensity, audio, or video.

16. The method of claim 12, wherein generating the augmented or virtual recreation of the real-time event includes combining captured audio and video data with the participant data, object data, and facility data.

17. The method of claim 16, wherein the captured audio data comprises three-dimensional audio.

18. A method for recreating a real-time event in virtual, augmented, or extended reality comprising:
triangulating positions of at least one object and at least one participant in the real-time event by collecting data from sensors located within a facility that is hosting the real-time event, including sensors located on the at least one object and at least one participant;
processing audio and visual data in combination with the triangulated positions; and
displaying processed audio and visual data to a spectator in virtual, augmented, or extended reality.

19. The method of claim 18, wherein processing audio and visual data with the triangulated position further comprises processing sensor data from an object sensor located on the at least one object and a participant sensor located on the at least on participant.

20. The method of claim 19, further comprising generating an avatar based on processed sensor data in combination with processed audio and visual data.
